(19) United States
(12) Patent Application Publication
(10) Pub. No.: US 2018/0286224 A1
(43) Pub. Date: Oct. 4, 2018

(54) System and method of traffic survey, traffic signal retiming and traffic control

(71) Applicant: Gregory Brodski, Warwcik, MA (US)

(72) Inventors: Gregory Brodski, Warwick, MA (US); Andrey Berkovsky, Saint -Petersburg (RU); Mikhail Bakhtin, Saint-Petersburg (RU); Nataliya Vinogradova, Moscow (RU)

(21) Appl. No.: 15/478,493

(22) Filed: Apr. 4, 2017

(51) Int. Cl. G08G 1/01

(52) U.S. Cl. CPC G08G 1/0137; G08G 1/0125; G08G 1/0112; G08G 1/0145

(57) ABSTRACT

An integrated system and a method of traffic survey, traffic signal retiming and traffic control, that collects individual travel time data for vehicles that are travelling along specially assigned controlled routes, equipped with GPS transmitters and willing to share travel information, sends this data to the processing unit furnished with the novel algorithm, which uses and analyzes the information on road patterns and traffic lights together with travel time data for identifying traffic patterns at all directions and further processes these data for optimization of traffic movements at given intersection(s), as well as for other tasks of traffic survey and traffic control.

### BACKGROUND OF THE INVENTION

This invention relates to a method and system of signal retiming based on novel algorithm that uses GPS information on vehicle travel time in order to survey traffic, design traffic light timing plans and perform traffic control.

Retiming of traffic signals is one of the most cost-effective ways of improving the traffic flow. Still, many traffic engineers do not have adequate budgetary resources to conduct signal retiming programs with conventional methods. Most of traffic lights currently operate according to “time of the day” or “pre-time control” programming. Each week is divided into a number of time intervals, with each interval being assigned to timing plan, allocating “red”, “yellow”, and “green” ranges. This schedule, comprising time intervals, timing plans and relationship between them, is loaded into the traffic light controllers that regulate commands directed to traffic lights at each controlled intersection. Traffic controllers have hardware limitations, which are considered in the course of timing plan development. For example, for FHWA 170-Type controllers the number of time intervals is limited to 64 per week, and the number of timing plans is limited to 18 per week. These limitations, however, are not reached in most cases, so the retiming quality is even worse than it would be based on the equipment capacity.

The tools, currently available for signal retiming, face three main challenges (i) lack of traffic patterns data capable of providing complete information on traffic demands in all directions (approaches, movements, links) of intersection; (ii) lack of tools for automated determination of timing intervals that have to be served by different timing plans; (iii) high labor consumption of the signal retiming process. The Adaptive Signal Control Technology (ASCT) that attempts to address these challenges has gained only limited popularity since its introduction in early 1960-s: its share of the traffic signal market is only at 5%. High cost of ASCT and its insufficient capabilities for saturated traffic control are likely responsible for such a low adoption rate. It is possible that real-time optimization opportunities will improve in the future (see, for example, S. F. Smith, G. J. Barlow et al. SURTRAC: Scalable Urban Traffic Control. Carnegie Mellon University, TRB 2013 annual meeting). Nevertheless, high cost of equipment, including but not limited to several advanced detectors required for each intersection, limits high prevalence of ACST technology.

Traffic detectors are employed to address the challenges related to the automation of data collection process. In order to get sufficient information for traffic signal optimization it is necessary to install a traffic detector on each approach (link) of each intersection. Due to the enormous number of intersections, the required number of detectors cannot be provided to serve the need of signal retiming. Therefore, automated counting with the use of portable equipment is widely used in the current practice (see, E Minge et al., Evaluation of non-intrusive technologies for traffic detection, MN DOT, 2010). Equipment cost and labor consumption of this technology is still too high to enable data collection for more than a couple of days per intersection, though.

As a result of these challenges, quality of signal timing In the USA had been assessed as ‘D+’ (US DOT Research and Innovative Technology Administration. Traffic signals case study, Component 1, 2013).

At the same time, during the last ten years another source of traffic information has been developed: travel time data collection through GPS traffic flow speed measurement (patent U.S. Pat. No. 9,053,632 B2 from Jun. 9, 2015). This information, however, is used now only for the purpose of travel time forecast or LOS (level of service) evaluation (B. Cameron. Evaluation of Signal Retiming Measures Using Bluetooth Travel Time Data. A thesis presented to the University of Waterloo in fulfillment of the thesis requirement for the degree of Master of Applied Science in Civil Engineering. Waterloo, Ontario, Canada, 2015).

The goal of this invention is to develop an automated process and an integrated system for signal re-timing by using a novel algorithm based on joint utilization of all available knowledge, including travel time GPS data, road network information and signal timing parameters. This system and method are also useful for traffic survey and traffic control purposes.

### BRIEF SUMMARY OF INVENTION

The present invention provides an integrated system and method for traffic signal retiming, traffic survey and traffic control. The innovative integrated system comprises components for road pattern description, GPS traffic data collection, data handling, analyzing and traffic pattern calculation/visualization, optimal timing plan determination, and traffic light control. Combined operation of these components supports the information stream from an initial data collection, through traffic flow survey, time interval assignments and signal timing optimization, culminating in a schedule of timing plans, providing a better level of service. The system obtains information on road network and each signalized intersection and analyses this information in combination with travel time data for each vehicle, producing a number of traffic survey results, i.e. average speed, flow volume, traffic density, traffic demand versus time for each link of controlled road network, and builds traffic patterns for each intersection. Using these traffic patterns, the system performs three-level signal timing optimization by determining the timing intervals, forming optimal timing plans for each day of the week, and reducing this set in optimal way to form a final traffic light controller schedule that makes allowance for the hardware limitations.

### BRIEF DESCRIPTION OF THE DRAWINGS

FIG. 1. Operating scheme for the invention.

This figure is a block diagram showing functional components of the invention.

FIG. 2. Traffic flow vs Space mean speed.

This figure is based on field test data performed for major urban street, shows poor correlation between direct measurements of traffic flow performed by conventional traffic detector, and space mean speed calculated from travel time values detected by GPS system.

FIG. 3. Traffic flow vs number of GPS-equipped vehicles registered during the field test.

This figure is based on field test data performed for major urban street, and shows poor correlation between traffic flow measured by conventional traffic detector, and counts for GPS-equipped vehicles.

FIG. 4. Traffic flow directly measured by conventional traffic detector and calculated by novel algorithm.

This figure is based on the field test data performed for an approach to major urban intersection and provides a comparison between the values of actual traffic flow and values calculated by the novel algorithm, based on combined analysis of travel time data, road patterns and signal timing parameters.

FIG. 5. Efficiency of present invention in comparison with other state-of-the-art technologies.

The figure compares standard performance indexes (see Highway Capacity Manual 2010) proven by ‘before and after’ studies of recent signal timing technologies

FIG. 6. Assignment of controlled route on GIS map.

This figure demonstrates allocation of route intervals from point A to point B depending on the goal of the analysis.

FIG. 7. Collection of road pattern information with ArteryLite software.

This figure illustrates the types of information that should be uploaded into RPD for further processing:

(i) factors for the calculation of saturation flow value, (ii) topological characteristics of road network, and

(iii) parameters of traffic signal timing.

FIG. 8. Collection of travel time data from GPS-equipped vehicles.

This figure, based on field test data performed for major urban intersection, shows a variety of information collected from GPS-equipped vehicles. For each controlled route GTDC collects: route code, day and time, length of controlled route, travel time statistics (average, standard deviation, median, minimum and maximum values, number of counts, etc.) The figure of plotting average speed illustrates difference of travel conditions on the conflicting approaches to the intersection.

FIG. 9. A set of Saturation Flow and Free Flow Speed values for Intersection #3.

The calculation of saturation flow values has been done according to HCM-2000 methodology based on road patterns data; free-flow speed values are calculated according to novel algorithm based on GPS travel time data.

FIG. 10. Flow-Density curve calibration.

This figure shows the example of ‘Mean space speed-Time’ function. These functions are calibrated for each controlled route based on previously calculated free flow speed and saturation flow values for this route. The example made for Intersection #3, southbound approach.

FIG. 11. Average Traffic Speed and Traffic Demand.

This Figure shows average traffic speed and traffic demand at northbound approach of Intersection #3, as shown by virtual traffic detector formed from a database of raw traffic data.

FIG. 12a. Determination of timing intervals characterized by substantially different traffic patterns.

This figure, originated from the field test performed for urban intersection #3, shows simultaneous change of traffic flow speed at all four intersection approaches during the day. Based on conventional pre-timing, operating agency assigned five timing intervals and calculated five timing plans to serve all 24 hours. Novel algorithm had discovered 16 intervals, each of which is characterized by substantially different combination of traffic conditions prevailing on conflict approaches. These differences are captured by distinct values and gradients of ‘Speed-Time’ functions on each interval. Adopting 16 intervals (from N1 to N16) with different timing plans allows substantial decrease of average delay during the day, in comparison with five previously adopted timing plans. In current practice for most intersections 5 timing intervals for the day (from 11 to 15) are assigned by operating agencies (3 to 5 distinct timing plans on weekdays and 1 to 3 distinct timing plans on weekend days). A number of recent studies indicate that this allocation does not adequately capture traffic needs, but rather is dictated by a compromise between constantly changing traffic demands and labor consumption of signal timing development.

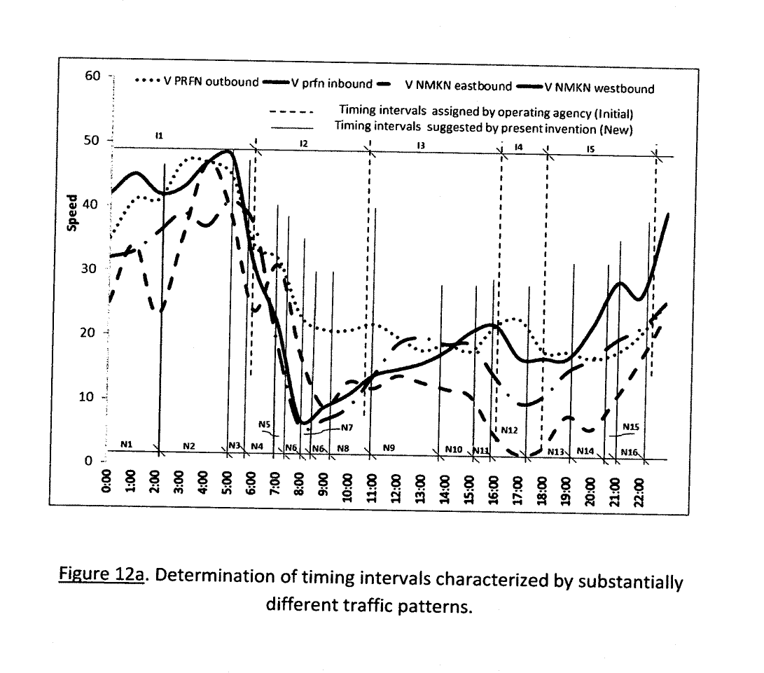

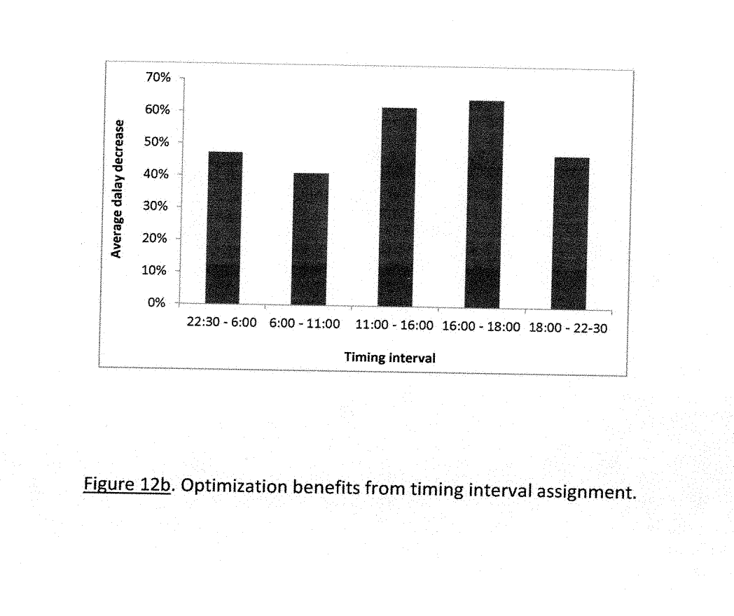

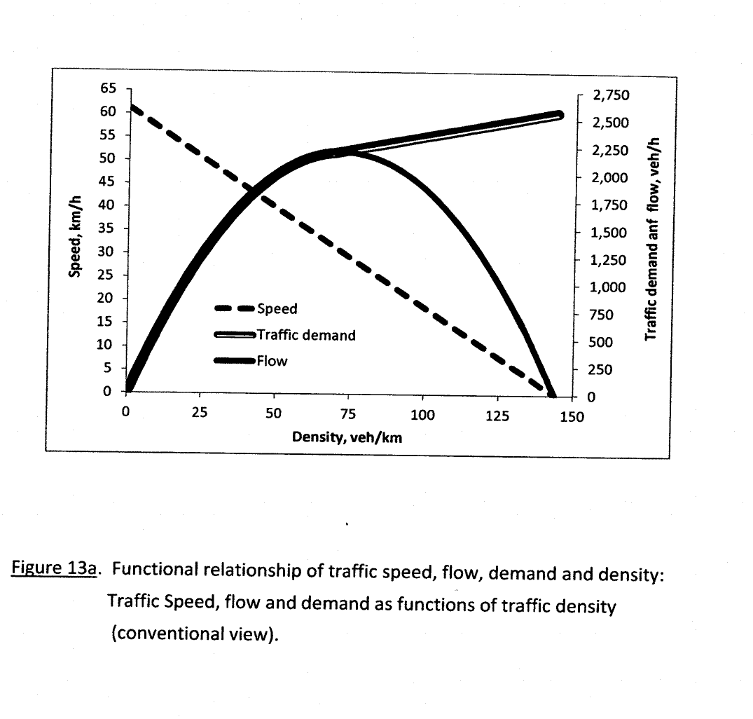

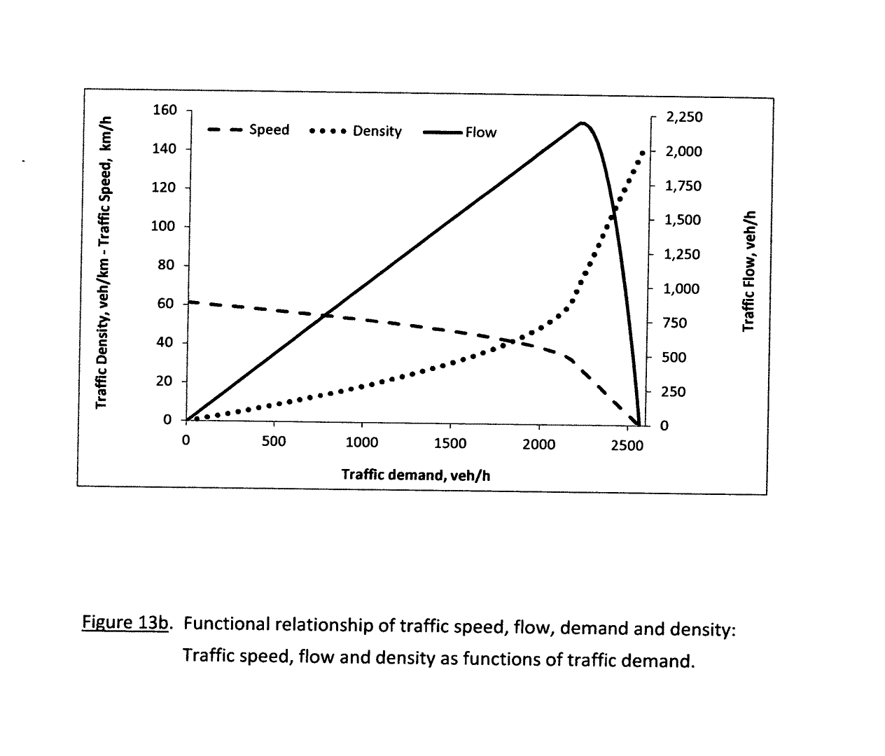

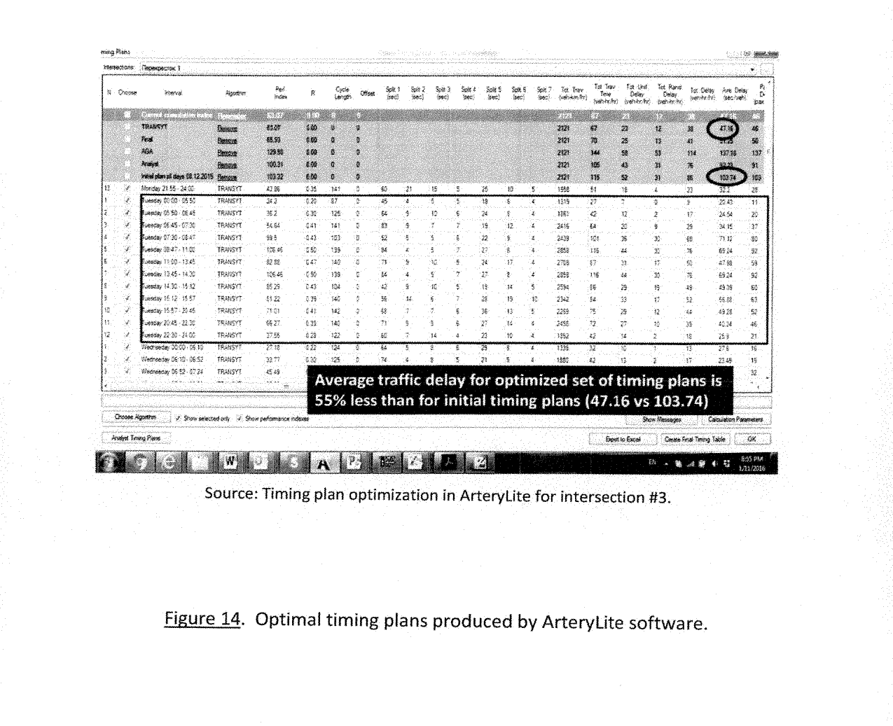

FIG. 12b. Optimization benefits from timing interval assignment.

This figure, created by using macro modeling in Transyt-7FR software, is based on the assignment of timing intervals made according to the invented method. It shows benefits to customers from adopting the invention on the example of one day of the week (Tuesday). Benefits are calculated for each ‘old’ interval, previously determined by the operating agency. Novel algorithm allocated 16 timing intervals instead of five. This assignment leads to optimization benefit between 35% and 60%, depending on the interval.

FIGS. 13a and 13b. Functional relationship between Traffic Speed, Flow Demand and Density.

FIG. 14. Optimal timing plans based on ArteryLite software.

This chart represents an optimization screen of ArteryLite software. It shows all cycle parameters and performance indexes for each timing intervals. Cumulative performance indexes for the entire optimization period (in this case—week) are calculated in the upper (grey) rows.

### DETAILED DESCRIPTION OF THE INVENTION

Note. All terms are used according to the book: N. J. Garber, L. A. Noel. Traffic and Highway Engineering. Second edition, PWS Publishing Co, NY, 1110 p.

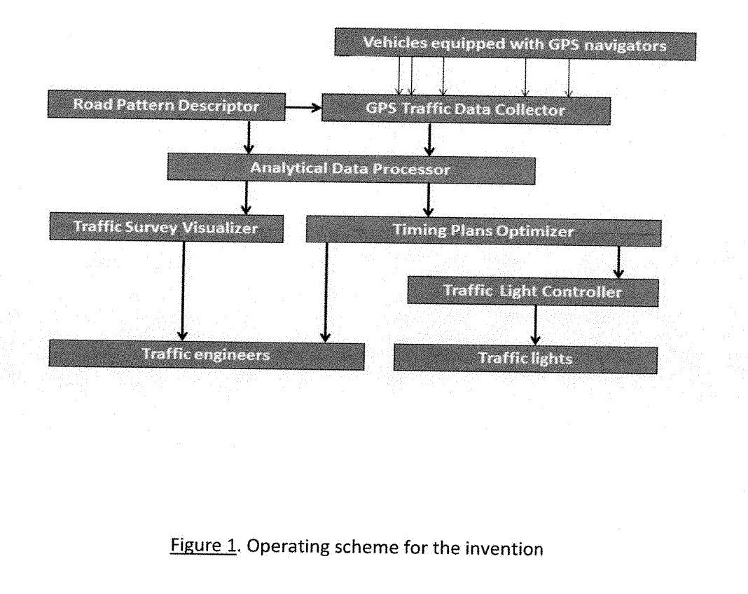

The present invention is a system and method for traffic survey and traffic signals retiming. The system consists of:
1. Road pattern descriptor (RPD);
2. GPS traffic data collector (GTDC);
3. Processor with novel algorithm for data processing, analyzing and calculation of traffic flows parameters (PA);
4. Traffic survey visualizer (TSV);
5. Timing plans optimizer (TPO);
6. Traffic lights controller (TLC).
7. Recipients of data and service: traffic lights—for signal timing plans, traffic engineers—for traffic survey information (FIG. 1).

The system conducts a combined analysis of travel time data, road patterns and parameters of signal timing. Against the expectations based on established consensus, the authors found that combined processing of these three types of data culminates in unexpected opportunity of signal timing optimization and helps in solving traffic survey tasks without costly installation of traffic detectors. RPD performs the following sequence of operation in order to collect and describe road network data:
Assigning of controlled routes (links), each of which represents a movement in a single direction on intersectional approach, including turning movements
Obtaining road pattern information about controlled traffic network, including sequences of links, and, for each link at least the following: number of lanes, lane width, lane utilization factor, grade, heavy vehicles adjustment factor, parking maneuvers frequency, number of public transportation stops, base saturation flow, area type, types of turning movements, pedestrian-bike influence on turns, and speed limits. This list may also include other traffic data, necessary for road capacity management and required by TPO or/and TSV;
Obtaining information about timing plans for traffic lights situated on controlled network including all cycle elements and offsets for each timing plan assigned;
Assigning GPS coordinates for start and end points of each controlled route;

With the exception of GPS coordinates, the above information is uploaded to PA and TPO. GPS coordinates for controlled routes start and end points are transmitted to GTDC.

GTDC continuously obtains individual travel time data for each vehicle equipped with GPS transmitters, travelling between start and end points of each link, and confirming the willingness to share this information. Periodically GTDC uploads collected data to PA. GTDC may perform an averaging of travel time measurements over 5-30 minutes to account for inertness of traffic flow.

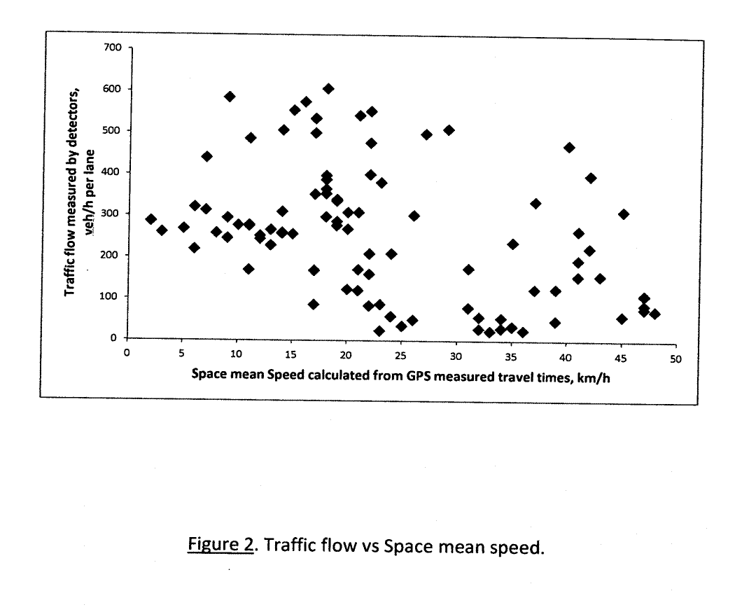

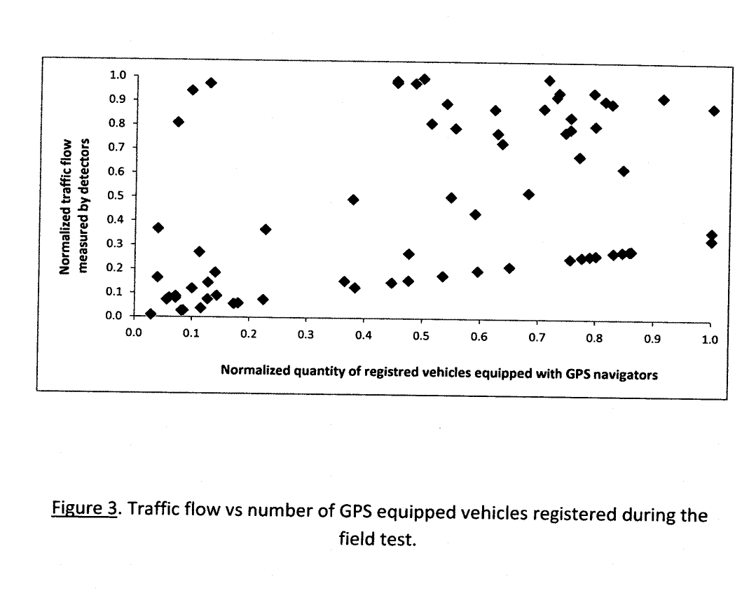

It is worth noting that all previous attempts to use travel time data for traffic flow assessments brought no results because of: (i) extremely high data volatility; (ii) lack of direct correlation between mean space speed and traffic flow. For instance, FIG. 2 illustrates this challenge in the context of one major street equipped with conventional traffic detector. Given the poor correlation between the number of vehicles and traffic volume, using the counts from GPS-equipped vehicles simplifies the problem (FIG. 3).

Novel algorithm introduced in the PA circumvents this challenge by building an accurate picture of traffic patterns through simultaneous analysis of travel time data, road patterns and signal timing parameters.

PA operates in two stages. The processor first prepares traffic survey results for TSV, and then PA forms traffic patterns for TPO.

Preparation of traffic survey results consists of the following steps:
Processing all travel time data to exclude the values that represent: (i) speed violation—by substituting all measurements in excess of the speed limit at the entire link with optimal speed values, (ii) abnormally low travel speed, by substituting all measurements that are several times lower than the average speed, with mean values;
Calculating free-flow travel time for each controlled route (link) based on processed travel time data. Free-flow travel time for the controlled route is calculated as minimal travel time recorded during fastest hour of travelling along each route;
Refining travel time data by: (i) filtering outlier values using the ‘three sigma’ rule or other statistical method, (ii) identifying those values for off-peak night hours that differ from the calculated value of Free-flow travel time by less than 30% and equating them to Free-flow travel time;
Calculating the value of saturation flow for each controlled route (link), using data downloaded from RPD, determining critical density and calibrating speed-density curve;
Calculating traffic density, traffic flow, and traffic demand for each controlled route (link), and establishing a database of raw traffic data, which includes all parameters, relative to controlled routes and time;
Uploading the database to TSV.

During the second stage of operation, PA prepares traffic patterns data for Timing Plan Optimizer:
Calculating the moving average relative to a continuity of collected travel time data, to ensure the sufficiency of collected information for all prospective intervals;
Forming the traffic pattern database from a number of functional relationships, such as ‘Traffic Demand-Time,’ or ‘Traffic Flow-Time,’ or ‘Traffic Speed-Time’ for all intersections. Uploading this data to TPO;

Timing plan optimizer (TPO) downloads road patterns from RPD and traffic patterns from PA and provides triple optimization of signal timing as follows:
Determining different timing intervals, each of which is served by a distinct timing plan based on traffic patterns. TPO may limit minimal duration of intervals, thereby expediting the inertia of traffic flow. In addition, hardware constraints may lead to a reduction in the number of timing intervals recommended for a week. If this is the case, TPO will reduce the number of timing intervals by sequential joining of intervals with the smallest difference between them;
Calculating a timing plan for each timing interval above using any optimization software or any calculation method, and forming a set of optimal timing plans for a week;
Setting allowance for the maximum number of different timing plans for a week and reducing a set by sequential joining of least differ timing plans;
Forming final, optimally reduced schedule of timing plans for a week for each signalized intersection located on controlled network;
Uploading a schedule to each traffic light controller.

Field testing performed at several major intersections in three Russian cities (Moscow, Yaroslavl, Ufa) have shown extremely high efficiency of novel algorithm, method and system proposed by this invention.

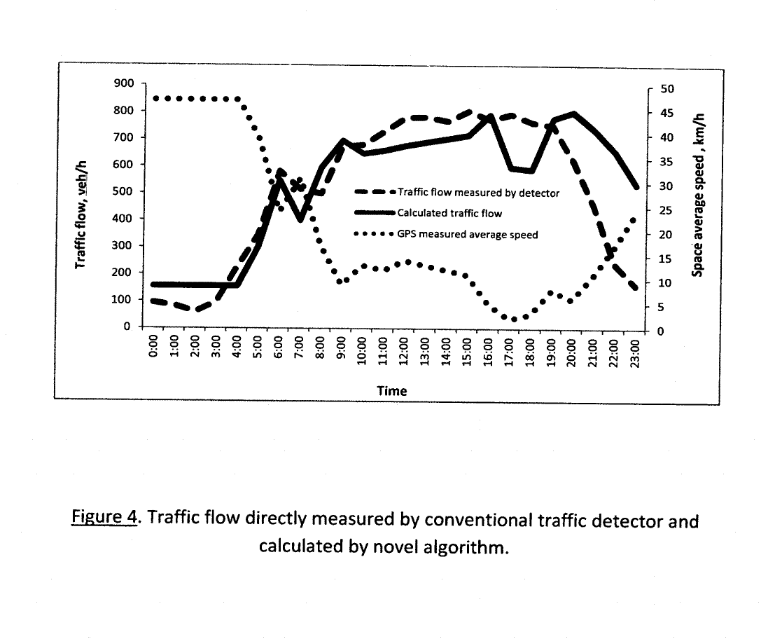

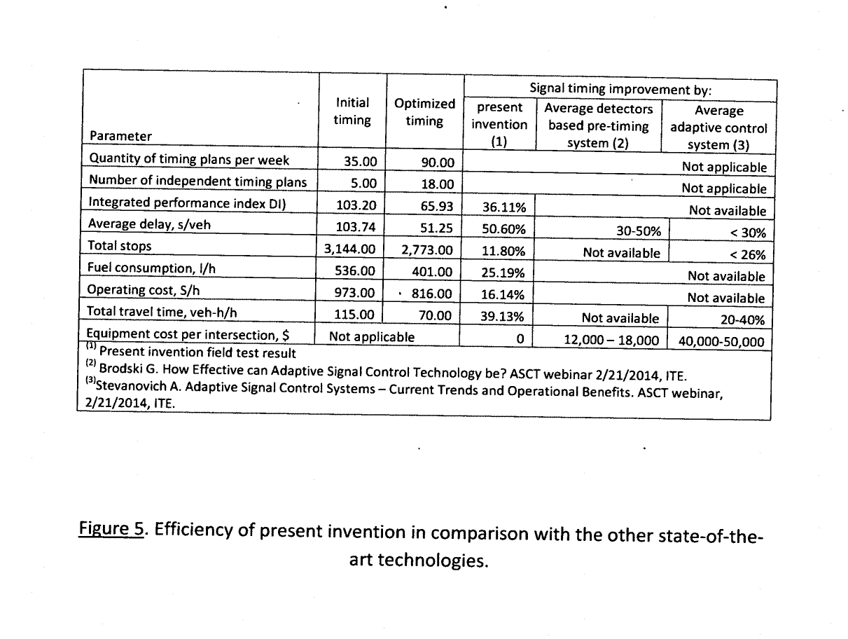

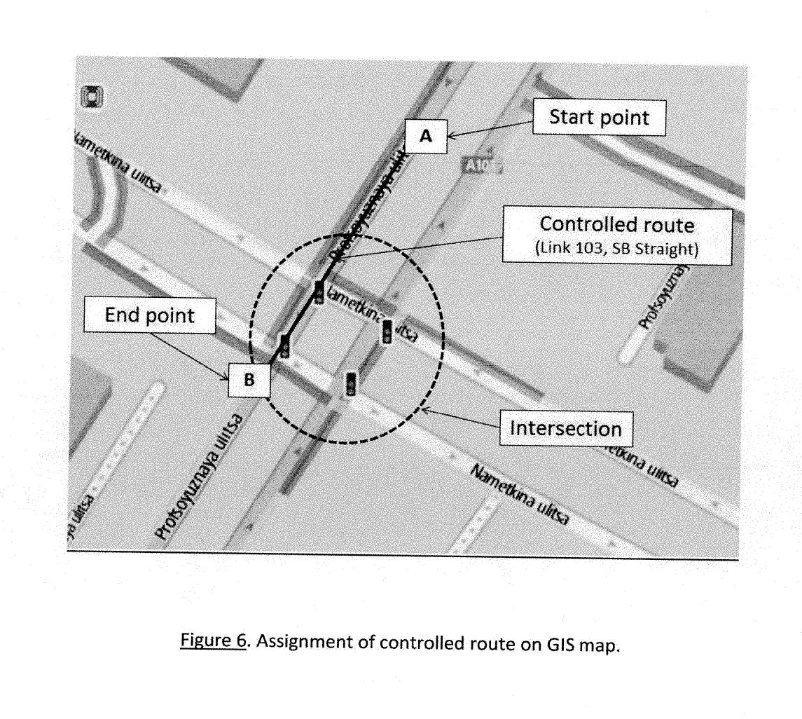

Since three test intersections in Moscow were equipped with state of the art traffic detectors on each approach, it was possible to verify high accuracy of calculations made by the novel algorithm, by comparing it to the direct measurements (FIG. 4). Seven additional intersections in two different cities not equipped with full scale detection, were studied to identify regularities of GPS data and the efficiency of the invention. These studies have shown high accuracy and efficiency of the novel method, as well as significant reduction of labor consumption for signal timing.

FIG. 5 shows the performance of the invention relative to the competition. Field tests prove that the novel system and method are at least as effective as recent state-of-the-art pre-timed, and even adaptive, technologies. At the same time, the invention provides substantial reduction in costs stemming from eliminating the need for purchase, installation and management of expensive equipment.

### EXAMPLE OF THE USE OF THE INVENTION

The example below illustrates the use of the invention for traffic survey and signal timing optimization for the intersection #3 (code: PRFN/NMKN).

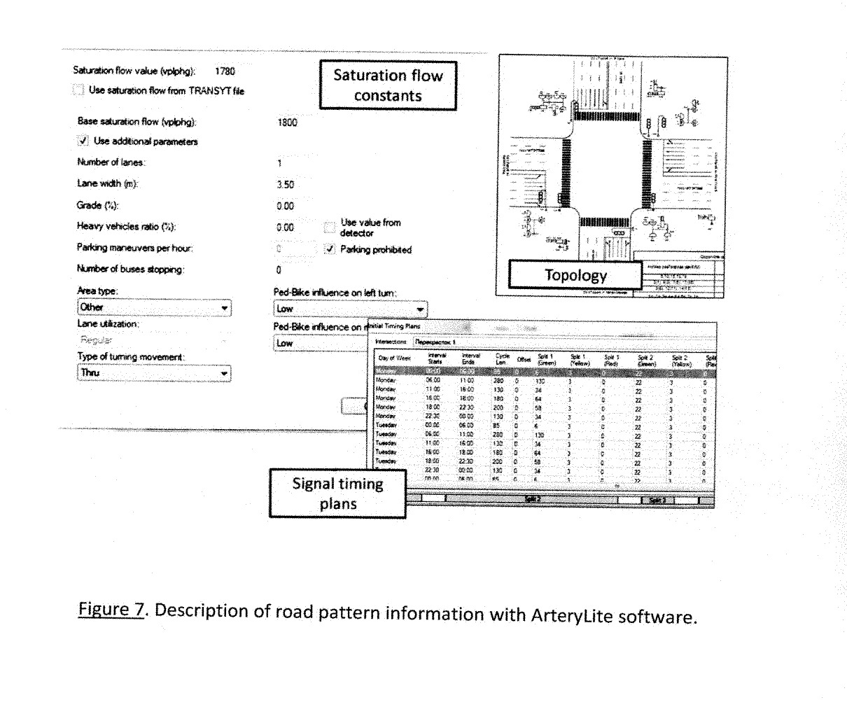

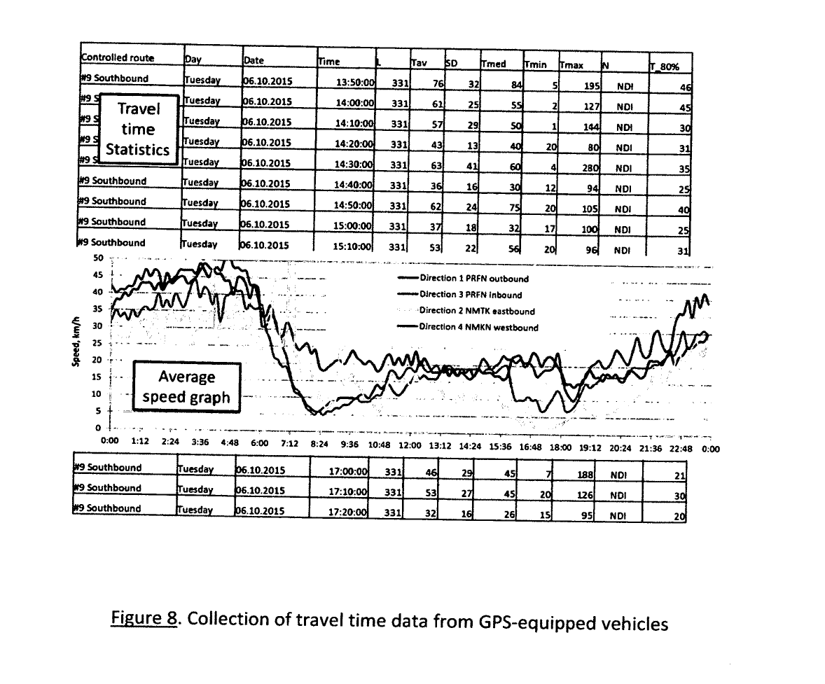

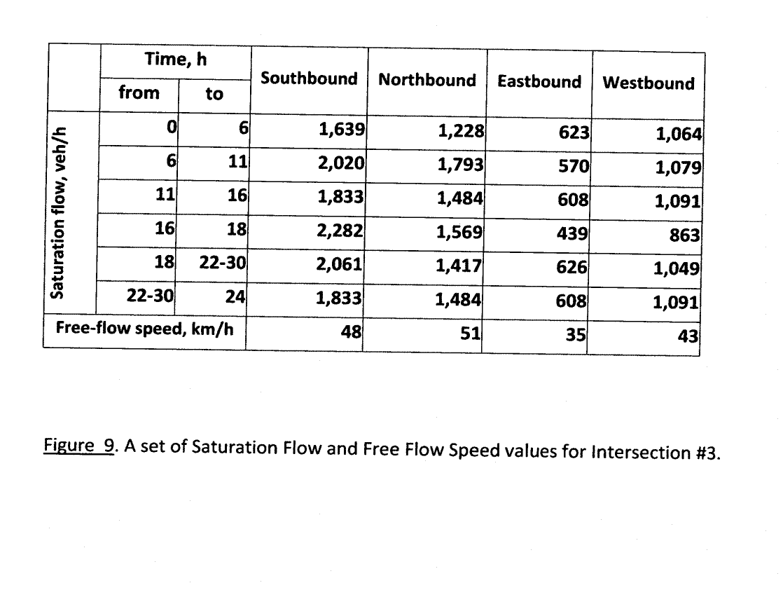

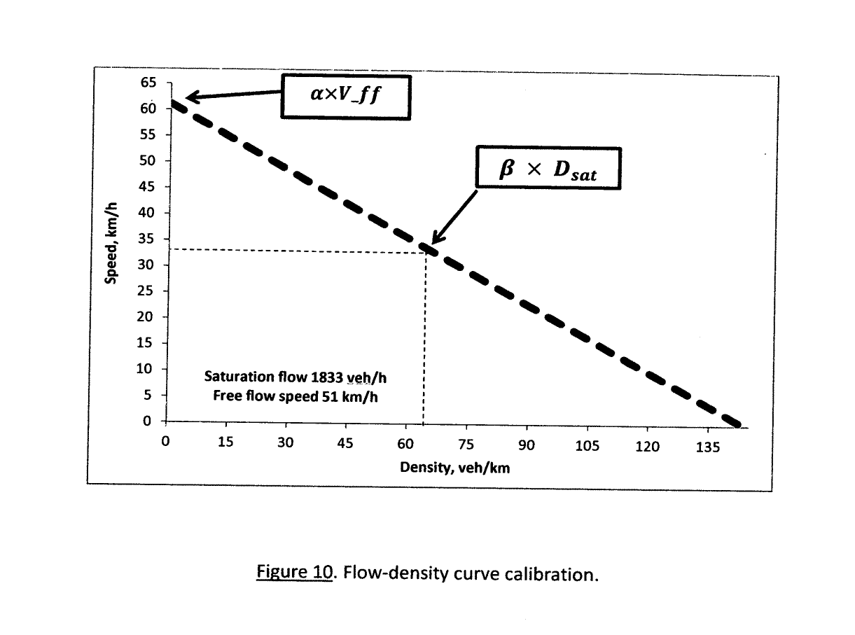

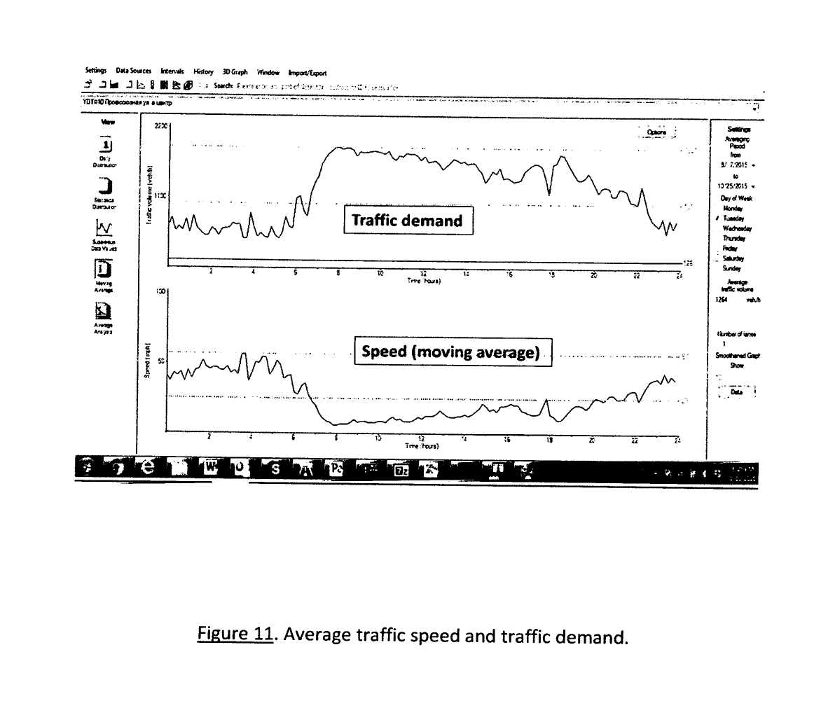

The description of controlled routes (intersection approaches, each 300 to 600 m long) was done using GIS system operating in the three Russian cities mentioned above (FIG. 6). Road pattern information was obtained during regular traffic inspection and modelling with Transyt-7FR and ArteryLite software (FIG. 7). Travel time data were obtained from each vehicle equipped with GPS and willing to provide the information to the system (FIG. 8). GPS data collection was performed from the navigation operator. Mean space speed for each 10-minute interval was calculated based on individual travel time values. To further refine travel time data, suspect values were filtered using ‘three sigma’ rule. Measurements that represent speed violation and abnormally low travel speed were substituted with the mean space speed value. As a result, a function ‘Mean space speed-time’ was formed for each approach of the intersection. Further, free flow speeds and saturation flow values for all approaches were defined (FIG. 9) to calibrate ‘Flow-Density’ curves (FIG. 10). ‘Mean space speed-Time’ and calibrated ‘Flow-Density’ curves for each approach serve as a base for Traffic Density, Traffic Flow, Traffic Demand calculation, and construct a database of raw traffic data. From this database TSV can display information in a standard form, as is the case with regular traffic detector (FIG. 11).

The authors used their proprietary software, ArteryLite, which satisfied the needs of the invention. First, ArteryLite determines timing intervals characterized by substantially different traffic patterns (FIG. 12), and, consequently, requiring different timing plans. ArteryLite finds all time periods for which cumulative vector of traffic demands at all links does not change for at least 10-40%, and assigns this period as a timing interval, for which a distinct timing plan needs to be computed. Arterylite then computes optimal timing plan for each timing interval using the traffic pattern database.

For the optimization of each timing plan the conventional programs, like Synchro, Transyt-14, Transyt-7FR, Vistro, etc. use a set of traffic flow values for all links. ArteryLite can operate in the same manner. Additionally, the invention improves the approach to signal timing optimization, enabling the use of a set of traffic demand values instead of traffic flow ones. Indeed, from a certain threshold of traffic density further growth of traffic demand leads to a reduction of traffic flow (FIG. 13). The computation based on a set of traffic flow values leads to a reduction in the effective green for oversaturated approach, further degrading the level of service. Instead, to better serve the increased traffic demand, effective green should be extended even if real traffic flow is decreasing. This approach allows for a dramatic increase in intersection capacity, especially in oversaturated conditions. FIG. 14 shows a set of optimal timing plans computed by ArteryLite based on ‘Traffic demand-Time’ functions. Macro modelling in Transyt-7FR has shown high efficiency of this optimization. Average traffic delay decreased by 55%, from 103.74 to 47.16 s/veh, total travel time—from 115 to 67 veh-h/h, total stops—from 3144 to 2740 veh/h, fuel consumption—from 536 to 391 I/h, operation cost—from 973 to 805 $/h. To achieve this dramatic improvement of traffic conditions at this particular intersection it is necessary to serve 90 timing intervals by 56 different timing plans per week.

Total labor consumption for signal timing development, including data collection, data processing and signal timing development did not exceed 3 man-hours. This is at least 7 times less than the average allowance adopted in the USA for a typical intersection pre-timing design with 3-5 different timing plans for Mondays-Fridays and 1-3 different timing plans for Saturdays-Sundays.

1. An integrated system comprising a road pattern descriptor, GPS traffic data collector, processor with novel algorithm for data handling, analysis and traffic patterns calculation, traffic survey visualizer, timing plan optimizer, traffic light controller, wherein all constituents employed for joint operation.

2. A method for traffic control:
a. assigning controlled routes, each of which represents a movement in a single direction;
b. obtaining road pattern information about controlled traffic network;
c. obtaining information about timing plans for traffic lights located on controlled network;
d. collecting individual travel time data for vehicles that are equipped with GPS transmitters, travelling between start and end points of each controlled route (link) and willing to share information with integrated system;
e. processing all collected travel time data to exclude measurements representing speed violation, intentionally low speed travelling and parking;
f. calculating free-flow speed for each controlled route based on processed travel time data;
g. calculating saturation flow for each controlled route based on road pattern and timing plans information obtained;
h. calibrating speed-density curve using calculated values of saturation flow and free-flow speed;
i. calculating traffic speed, traffic density, traffic flow, traffic demand for each controlled route, and establishing a database of raw traffic data that includes all parameters above in relation to time for each controlled route;
j. determining timing intervals characterized by substantially different traffic patterns, and therefore requiring different timing plans to ensure optimal control of the intersection;
k. setting allowances for maximum number of timing intervals for a designated period of time, and reducing the number of timing intervals to allowed number by sequential joining of timing intervals based on a pre-specified thresholds;
I. determining (calculating and/or optimizing) a timing plan for each timing interval, and forming a set of optimal timing plans for a designated period of time (day, week, etc.);
m. setting allowances for maximum number of distinct timing plans for each designated period of time, and reducing a set of optimal timing plans to allowed number by sequential joining of timing plans based on a pre-specified threshold;
n. forming a final, optimally reduced, schedule of timing intervals and timing plans for a week for each traffic light located on controlled network;
o. sending computer instructions to traffic light controller and operating with traffic lights, changing timing plans according to final schedule.

3. A method of claim 2, wherein road pattern information comprises all parameters of the road network, including but not limited to the following: sequences of links, and, for each link: number of lanes, lane width, lane utilization ratio, grade, ratio of heavy vehicles, frequency of parking maneuvers, number of public transportation stops, base saturation flow, area type, types of turning movements, pedestrian-bike influence on turns, speed limits.

4. A method of claim 2, wherein controlled traffic network includes but is not limited to roads, intersections and traffic control equipment within a given area.

5. A method of claim 2, wherein determination (calculation and/or optimizing) of timing plans is based on traffic demand values;

6. A method of claim 2, wherein determination (calculation and/or optimizing) of timing plans is based on average space speed values with or without consideration of standard deviation factor;

7. A system of claim 1, using discrete traffic flow speed data (usually four grades) publically available from GIS providers and traffic detection/counting data publically available from traffic agencies instead of GPS traffic data collector, with manually assignment of turning movements parameters based on user's expertise;

8. A method of claim 2 based on the use of discrete traffic flow speed data, wherein Free-Flow Speed for each controlled route (link) is calculated based on speed limit, road patterns and timing plans parameters;

9. A system of claim 1, wherein GTDC averaging individual travel time data over a time period from 5 to 20 minutes before uploading it to PA;

10. A method of claim 2, wherein certain time limitation can be set to the duration of timing intervals, including but not limited to minimum interval duration of 15-35 minutes;

11. A method of claim 2, wherein travel time data is further refined by filtering suspicious values, based on statistical methods;

12. A method of claim 2 wherein travel time data is further refines by equating all measurements that were obtained during off-peak night hours and that are differ from the calculated value of Free-Flow travel time by less than 20%-50%.
